(19) United States
(12) Patent Application Publication
(10) Pub. No.: US 2010/0076671 A1
(43) Pub. Date: Mar. 25, 2010

(54) METHOD FOR PROVIDING A TRAFFIC PATTERN FOR NAVIGATION MAP DATA AND NAVIGATION MAP DATA

(75) Inventors: Alexey Pryakhin, Munchen (DE); Peter Kunath, Munchen (DE)

Correspondence Address: THE ECLIPSE GROUP LLP, 10605 BALBOA BLVD., SUITE 300, GRANADA HILLS, CA, 91344, US

(73) Assignee: Harman Becker Automotive Systems GmbH, Karlsbad (DE)

(21) Appl. No.: 12/407,668

(22) Filed: Mar. 19, 2009

(30) Foreign Application Priority Data
Mar. 19, 2008 (EP) EP 08 005 151.9

(51) Int. Cl. G01C 21/36; G08G 1/00

(52) U.S. Cl. 701/119; 701/200

(57) ABSTRACT

Methods and systems for providing a traffic pattern for a road segment of navigation map data on the basis of time series traffic data is provided. Reference time series are determined for the road segment to use to approximate the time series traffic data. A weighted combination of the reference time series is determined by determining weighted coefficients that determine how much a predetermined reference time series contributes to the combination of the reference time series for approximating the time series traffic data. The time series traffic data is then approximated using the weighted combination of the reference time series. The determined weighting coefficients are then linked to the road segment of the navigation map data.

### RELATED APPLICATIONS

This application claims priority of European Patent Application Serial Number 08 005 151.9 filed Mar. 19, 2008, titled METHOD FOR PROVIDING A TRAFFIC PATTERN FOR NAVIGATION MAP DATA AND NAVIGATION MAP DATA, which application is incorporated in its entirety by reference in this application.

### BACKGROUND

1. Field of the Invention

This invention relates to navigation systems, and more particularly, to methods for providing traffic patterns for a road segment of navigation map data.

2. Related Art

Traffic detection systems include systems that monitor the velocities of vehicles for road segments having sensors for detecting the velocity of the vehicles driving past on the road segments. These sensors provide information relating to raw traffic patterns for each road segment. The information may include a large amount of data for the many road segments that may be monitored using the sensors. The large amount of independent measurements generated by the sensors may be used to build time series traffic data. The amount of data generated may be so large that it is difficult to use these time series traffic data in the context of navigation systems. One problem may be that not enough storage space is provided to store the complete time series traffic data for each road segment.

Accordingly, a need exists for ways to use traffic patterns provided on the basis of time series traffic data in a navigation system.

### SUMMARY

In view of the above, an example method for providing a traffic pattern for a road segment of navigation map data on the basis of time series traffic data is provided. The example method determines reference time series for the road segment to use to approximate the time series traffic data. A weighted combination of the reference time series is determined by determining weighted coefficients that determine how much a predetermined reference time series contributes to the combination of the reference time series for approximating the time series traffic data. The time series traffic data is then approximated using the weighted combination of the reference time series. The determined weighting coefficients are then linked to the road segment of the navigation map data.

In another aspect, an example of a system for providing a traffic pattern for a road segment on the basis of time series traffic data is provided. The time series traffic data includes time-dependent mean velocities of the road segment. The system includes a reference time series determining unit for determining reference time series for the road segment, the reference time series containing time-dependent mean velocities for the road segment. A weighting coefficient determining unit determines weighting coefficients for the road segment used for approximating the time series traffic data by a weighted combination of the reference time series. The reference time series are weighted using weighting coefficients that determine how much a predetermined reference time series ρ(t) contributes to the combination of the reference time series. A storage unit stores the determined weighting coefficients in connection with the road segment.

In other aspects of the invention, navigation systems and methods are provided for determining traffic patterns and using the traffic patterns in determining routes to a predetermined destination.

Other devices, apparatus, systems, methods, features and advantages of the examples consistent with the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a block diagram of an example of a system for calculating and using weighting coefficients and weighting time series in a navigation system.

FIG. 2 is a graph depicting a typical traffic pattern as time series traffic data.

FIG. 3 illustrates an example of approximating an original time series data by reference time series.

FIG. 4 is a flowchart of an example method for determining the weighting coefficients.

FIG. 5 is a flowchart of an example for calculating a route using weighting coefficients.

### DETAILED DESCRIPTION

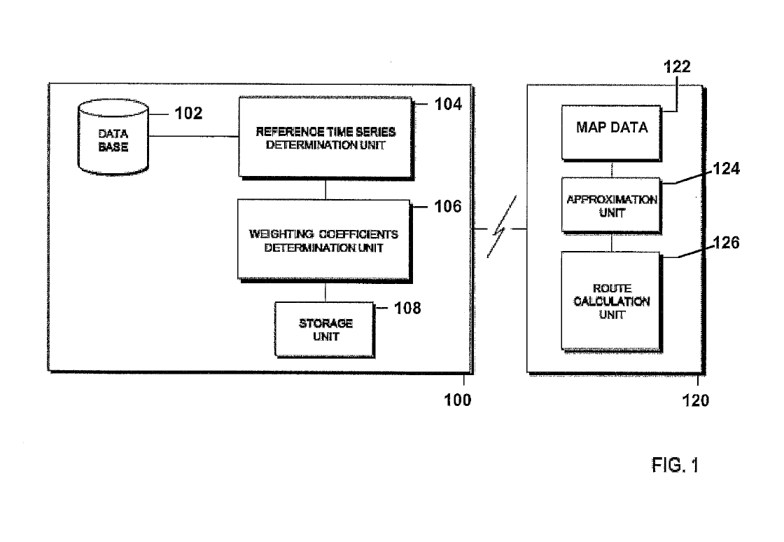

FIG. 1 is a block diagram of an example of a traffic pattern providing system 100 for calculating weighting coefficients and weighting time series for use in a navigation system 120. The traffic pattern providing system 100 in FIG. 1 performs a compression or transformation of originally detected time series traffic data, which may then be used by the navigation system 120. The traffic pattern providing system 100 includes a database 102, a reference time series determination unit 104, a weighting coefficients determination unit 106, and a storage unit 108. The navigation system 120 includes map data 122, an approximation unit 124, and a route calculation unit 126.

The systems 100, 120 shown in FIG. 1 may be incorporated into one unit for carrying out the determination of the weighting coefficients and of the reference time series, and then for applying the calculated data in the navigation system 120. The traffic pattern providing system 100 and the system 120 may also be located in different geographical regions. The navigation system 120 may be incorporated into a moving vehicle, and the traffic pattern providing system 100 may be an installed unit that determines the weighing coefficients and the reference time series for a plurality of users.

The traffic pattern providing system 100 includes a database 102, which stores the time series traffic data Y(t). The time series traffic data may include the mean velocity for a certain road segment depending on time. As navigation map data for vehicle navigation normally includes map data for a large geographical region, such as an entire country or an entire continent, the amount of time series traffic data can be quite large. Not all road segments of the map data may have traffic patterns. For example, the traffic patterns may exist for some important road segments of the map data.

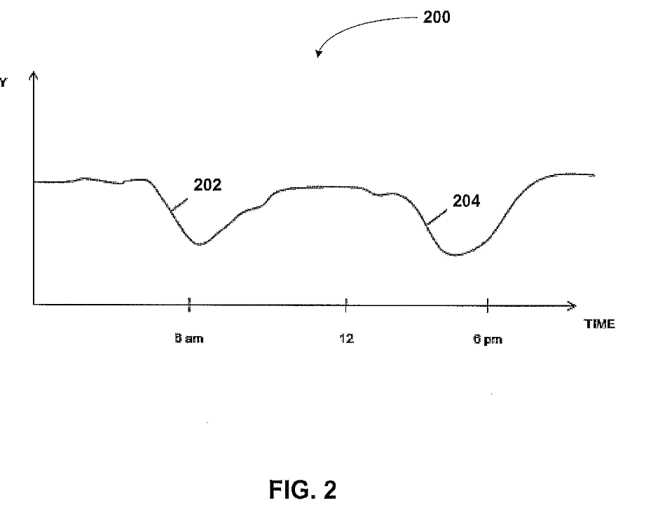

FIG. 2 is a graph depicting an example of a traffic pattern as time series traffic data. The time series traffic data shown in FIG. 2 is an example of a velocity distribution 200 over time for a road segment. That is, the velocity distribution 200 in FIG. 2 depicts the mean velocity for the road segment as a function of time. The road segment may be a segment or section of a road located in an urban agglomeration. During the night until five or six a.m. in the morning, the average velocity of the detected vehicles is shown as relatively high in FIG. 2. The absolute value of the average velocity at such hours may be around the velocity allowed on the road segment. Commuter traffic in the morning due for example to people going to work along the road segment may cause the average velocity to drop as shown by a first recess 202 in the distribution 200 shown in FIG. 2. After the first traffic congestions in the morning, the mean velocity may again rise to a region of a more or less stable plateau. During the time following the morning congestion, the mean velocity may be lower than the velocity during the night. In the afternoon, at around six p.m. for example, a second recess 204 in the mean velocity is formed resulting for example, from the commuter traffic from people returning from work. After the second recess 204, the mean velocity again increases until reaching levels similar to the relatively high levels reached during night time.

The traffic pattern in FIG. 2 illustrates an example of what a traffic pattern might look like for a given road segment. Traffic patterns may be different depending on where the road segment is located.

The amount of time series traffic data collected for a road segment depends on the frequency with which values are detected. For example, when a mean velocity is detected every quarter of an hour, 96 values are contained in the time series traffic data shown in FIG. 2. The time series traffic data contains 48 values when a mean velocity is detected every half an hour, and 24 values are contained in the time series traffic data when mean velocity is detected every hour. In order to obtain better temporal resolution, the frequency of detection of velocity values may be increased. Increasing the frequency with which velocity values are detected would, however, result in a greater volume of data.

Returning to FIG. 1, the reference time series are determined in the determination unit 104. The reference time series may be determined using some representatives of the time series traffic data. The representatives may be calculated using clustering algorithms in which the time series are compared to each other in order to determine the similarities of the time series. The similarities may be determined using a similarity measure for time series. Examples of similarity measures for time series include, without limitation:
the Lp-distance,
Euclidean distance, or the edit distance,
dynamic time warping (DTW),
edit distance with real penalty (ERP),
edit distance on real sequences (EDR), or
longest common subsequence (LCSS).

The similarity measures indicate dependencies between different time series traffic data from which a basic set of reference time series, or representatives, may be determined and with which all of other time series traffic data may be calculated. Each time series may be represented by an adequate combination of a set of specific reference time series. The similarity distance used for clustering may be computed by applying parameters, such as for example, weighting coefficients that specify the combination.

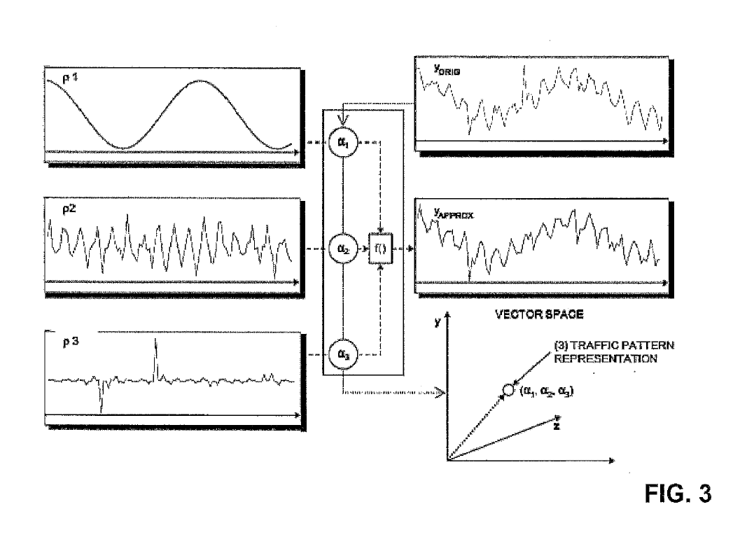

FIG. 3 illustrates an example of approximating an original time series data by reference time series. A set of reference time series, identified in FIG. 3 as ρ₁, ρ₂ and ρ₃, is used to approximate an original time series Y_{orig} by an arbitrary complex combination Yₐₚₚᵣₒₓ. A combination of the coefficients of α₁, α₂ and α₃ in FIG. 3 represents weighting of three reference time series. In the illustrated example, the approximated time series representing the approximated time series traffic data can be determined by the following equation:

Yₐₚₚᵣₒₓ=αᵢ·ρ₁+α₂·ρ₂+α₃·ρ₃ (1)

As shown in the right-hand part of FIG. 3, the graph for the approximated time series Yₐₚₚᵣₒₓ is similar to the graph of the original time signal Y_{orig}.

If the database 102 contains very large amounts of traffic data, the clustering techniques mentioned above may also be applied to the weighting coefficients and not to the original time series traffic data in order to minimize the computing power needed to calculate the representatives. The resulting representation includes a low-dimensional feature vector that can be indexed by means of any spatial index structure. The cost for the clustering process would then depend only on the number of reference time series rather than on the length of the time series. In the clustering process, the approximation may be represented by a feature vector of the coefficients of the combination. For example, the feature vector may be represented by (α₁, α₂, α₃).

The weighting coefficients α₁, α₂, and α₃ can be calculated in the weighting coefficients determination unit 106 shown in FIG. 1. In one example, during the approximation process, the weighting coefficients, a, are the quantities that are estimated. Once the reference time series ρ₁-ρ₂ are determined, k being the number of representatives, the corresponding weighting parameters α₁-αₖ can be calculated by finding the best fitting solution. A minimization process may be performed to calculate the suitable weighting parameters α. An example process for a linear regression approach that may be used is a least square estimation fitting.

For example, a complex set of time series traffic data Y(t) may be approximated using a mathematical model with four reference time series ρ₁, ρ₂, ρ₃ and ρ₄. The mathematical model describing Y(t) includes the set of reference time series ρ₁-ρ₄ and the function

f(ρ,α)=+α₁·ρ₁+α₂·ρ₂+α₃·ρ₃+α₄·ρ₄ (2)

The weighting coefficients α₁-α₄ are used to approximate the complex time series traffic data Y(t). This approximation provides a description of the relationship between the time series traffic data and a set of reference time series. In general, any complex mathematical function, such as a combination of quadratic or logarithmical functions, may be used to approximate the relationship. A small set of model parameters, such as for example, the reference time series, may be used to model all time series traffic data, where the reference time series are identical for all time series traffic data in the database 102. The size of the representation, which is the number of reference time series, is independent of the length of the time series in the database 102. The precision of the approximation of the model-based representation may only depend on the applied model function and the reference time series. Once the reference time series ρ₁-ρₖ and the corresponding weighting coefficients α₁-α₄ for each road segments have been determined, the weighting coefficients may be stored in a storage unit 108. The storage unit may be organized such that the weighting coefficients are related to their corresponding road segments, or the weighting coefficients may be stored separately with a position link used to the weighting coefficients to the corresponding road segments. The reference time series determined in reference time series determining unit 104 may also be stored in the storage unit 108 for use by the navigation system 120 in approximating the traffic patterns in the database 102.

In general, the reference time series should have a high correlation to a subset of the remaining time series in the database 102. In one example implementation, the reference time series ρ(t) are determined by selecting a limited number of representatives of the time series traffic data of the map data. For example, it is possible to extract some representative time series traffic data from the time series traffic data of a predetermined geographical region, such as a city. The extracted representatives describe the time series traffic data of the other road segments of the geographical region by a linear combination using the representatives. The representatives may be time series traffic data of a larger road, such as an arterial road or a radial highway in an urban agglomeration. When lots of traffic is detected on such roads, it may be deduced that the vehicle passing on these roads may later be detected on other roads connected to the representative roads. The representatives of the time series traffic data may be determined by mathematical methods, such as clustering analysis, e.g., partitioning clustering, model-based clustering, density-based clustering or agglomerative clustering. For example, clustering algorithms such as PAM (Partitioning Around Medoids) or CLARANS may be used. However, it is also possible to use methods such as OPTICS together with an additional selection of the representatives. The k-means method may also be used. However, the latter example uses artificial representatives and not representatives selected from the measured time series traffic data.

When the representatives are used as reference time series, the weighting coefficients for these representatives can be determined by a linear regression method in which the approximated time series traffic data for a road segment are compared to the time series traffic data of the road segment. For example, a least square fitting may be used to determine the coefficients.

Examples of implementations may also allow a user generating the reduced traffic pattern to determine the accuracy with which the original time series traffic data should be approximated by selecting a number of reference time series. The desired accuracy of the approximated time series data is affected by the number of reference time series selected. The number of reference time series may also be the maximum number of weighting coefficients used in approximation. For example, the reference time series may be determined by selecting a number, K, of reference time series to be used in approximating the time series traffic data. In general, the number, K, should be selected such that a difference between the time series traffic data Y(t) and an approximated traffic data using the weighted reference time series is smaller than a predetermined threshold. The K reference time series may be selected by clustering the time series data using a K medoid clustering method, such as for example, PAM, or CLARANS, or OPTICS. The clustering method yields a set of k cluster medoids (time series), each representing its corresponding cluster. All time series of a cluster are strongly correlated to the corresponding cluster medoid. These medoids may be used for the derivation of the reference time series. The computational costs may be reduced by performing the clustering algorithm on a small sample of data in the database 102. In example implementations, a sample rate of about one to ten percent of the data in the database 102 may be sufficient to obtain a high clustering accuracy.

In other example implementations, the reference time series may be determined by selecting standard basis functions, such as cosine or sine functions or wavelets. The selection of the standard basis functions may depend on the form of the time series traffic data shown in FIG. 2. If the time series traffic data includes sharp changes in the mean velocity, the use of wavelets may be used. For other cases, the use of trigonometric functions may be used to approximate time series traffic data as shown in FIG. 2. The standard basis function may also include any polynomial of grade n. When such standard basis functions are used, only a few weighting coefficients may be needed for approximating the original time series traffic data. For example, the higher order coefficients needed to exactly describe the time series traffic data may be omitted. The function Y(t) may be described using a set of standard basis functions as a new basis. A basis transformation may be performed to provide the weighting coefficients in a transformation matrix needed to describe the time series traffic data Y(t) in the selected basis.

The weighting coefficients may be determined using at least one of the following methods: the Discrete Fourier Transformation (DFT), the Fast Fourier Transformation (FFT), the Discrete Wavelet Transformation (DWT), the Discrete Cosine Transformation (DCT), or the Single Value Decomposition (SVD), which determine the standard basis function. For example, if a Cosine Transformation is used, the standard basis functions are cosine functions. Chebychev polynomials may also be used. These are only some of the possible standard basis function methods that can be used in the present context. It should be understood that any other transform may be used. The standard basis function may be selected in view of the geometrical form of the time series data. It is also possible to determine the weighting coefficients using a Piecewise Aggregated Information (PAA) method or an Adaptive Piecewise Constant Approximation (APCA) method in which the time series traffic data is divided in several segments and a mean value for each segment is determined. If representatives are used as reference time series, these representatives need not to be orthogonal to each other, as it is normally the case for the standard basis functions.

These standard basis functions may form the basis that is used to describe the original time series traffic data Y_{orig}. The coefficients α₁-αₖ may be determined using a basis transformation. The coefficients, αᵢ-αₖ, describe the original time series traffic data on a basis that is based on the basis function ρ. A transformation matrix may be calculated to generate the weighting coefficients α using standard mathematical procedures. Only a few coefficients α₁-αₖ may be needed to approximate the original time series traffic data Y_{orig}. The result is a low-dimensional feature vector that can be stored in connection with the road segment for which it was calculated.

The weighting coefficients may also be determined for the statistical moments of higher order (e.g., variance, skewness, kurtosis). The time series traffic data may describe a mean velocity for the road segment over time. The time series may also describe variance of traffic data providing an indication of the variation of the velocity of the road segment. A measure of the accuracy of the velocity may be obtained with reconstruction of variance time series calculated for the velocity variance of a road segment. The variance values for the different sets of traffic patterns may be regarded as a data set for which weighting coefficients, or variance weighting coefficients, may be determined to describe the variance of the different data sets. It is also possible to additionally calculate the weighting coefficients for the skewness or the kurtosis of the traffic patterns and to store these data together with the weighting coefficients of mean velocity.

The weighting coefficients determined using either the basis transformation and standard basis functions, or using several representatives of the time series traffic data, may be stored together with the road segment data for which the calculation was carried out. However, it is also possible to store the weighting coefficients for each road segment in a separate coefficients table with position information linking the weighting coefficients to the different road segments. The weighting coefficients and the reference time series may be transmitted to a storage unit, which may also be used to store the navigation map data. The transmitted weighting coefficients can then be stored together with the road segments. The reference time series may also be stored in the storage unit with the weighting coefficients used to calculate the approximated time series traffic data in a navigation application. It should be understood that the weighting coefficients, and the reference time series may also be determined in the same system in which the navigation map data are stored for use by the driver. The time series traffic data may also be collected in a central data base server having a server unit or any other centralized processing unit for determining the reference time series and the weighting coefficients. When the server that calculates the reference time series and the weighting coefficients and the map data storage unit are provided in different geographical locations, the weighting coefficients and the corresponding reference time series may be transmitted to the navigation system using, for example, wireless transmission technology. For example, the data may be transmitted via a cellular communication network to the vehicle in which the navigation system is provided. A centralized calculation of the reference time series and the weighting coefficients provides for updating of the map data for a plurality of users as soon as new time series traffic data is available for a predetermined geographical region. The user does not have to purchase the complete data including map data and updated traffic patterns, however, it is possible to separately update the traffic patterns independent from the navigation map data.

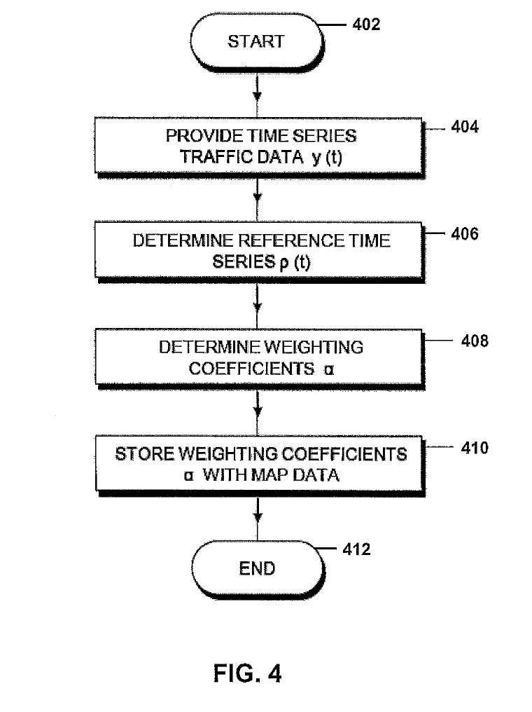

FIG. 4 is a flowchart of an example method 400 for determining the weighting coefficients. The flowchart illustrates operation of an example method 400 that provides a space-efficient mathematical representation of a time series traffic data. After the start of the method 400 at step 402, the time series traffic data is retrieved from the database 102 (in FIG. 1) at step 404. The retrieved original time series traffic data is used to determine the reference time series ρ(t) as shown in step 406. The reference time series may either be the representatives of the time series traffic data, or may be described by another basis, such as standard basis functions.

Once the reference time series are known, the weighting coefficients may be calculated at step 408. At step 410, the weighting coefficients may be stored in connection with the map data. At step 412, the map data may include time-dependent traffic patterns, which may be stored in the database 102 as the weighting coefficients that correspond to the different road segments.

Referring back to FIG. 1, the data calculated in the traffic pattern providing system 100 can be used in a navigation system as shown by the navigation system 120. The navigation system 120 includes map data for guiding a user from a present location to a predetermined destination. The navigation system 120 includes an approximation unit 124 that approximates the original time series traffic data Y_{orig} by:

$${Y}_{approx} = Y ( t ) \approx {\sum }_{n = 1}^{k} {α}_{n} {ρ}_{n} ( t ) \qquad ( 3 )$$

The time series traffic data Y(t) may be approximated using a linear combination of the reference time series ρ(t), each reference time series being weighted by the weighting coefficients αₙ, where Y(t) and ρ(t) include time-dependent mean velocities for a road segment. The resulting approximated time series traffic data Yₐₚₚᵣₒₓ(t) are an approximation of the original time series traffic data. However, instead of using the original time series traffic data having a large number of data points, for example, 30-100 data points describing the mean velocity for 24 hours on the road segment, the approximation allows for the use of the limited number of weighting coefficients αₙ for describing the time series traffic data. When the representatives are used as reference time series, the weighting coefficients may be determined by a linear regression method using a least square fitting.

The navigation system reconstructs the time-dependent velocities to determine, which route should be used to arrive at a predetermined destination depending on the time of the day. The approximation unit 124 uses the reference time series determined in reference time series determination unit 104 to calculate the approximated time series traffic data. The route calculation unit 126 calculates the route on the basis of the data calculated by the approximation unit 124.

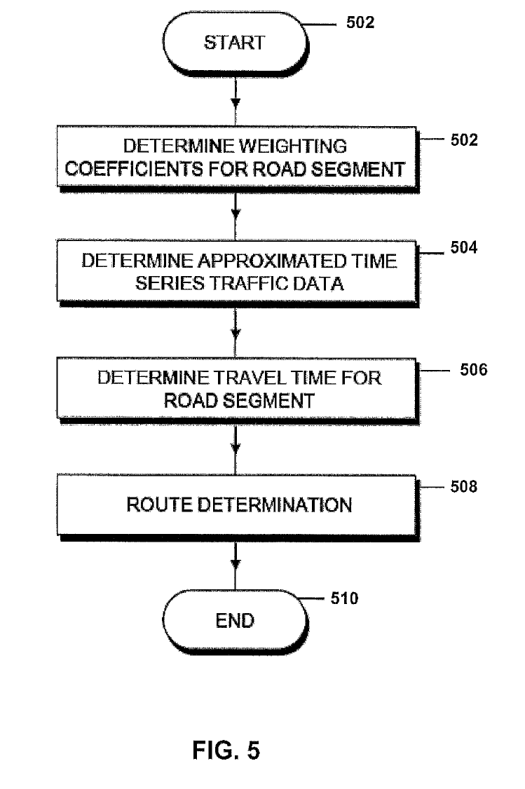

FIG. 5 is a flowchart 500 of an example of a method for calculating a route using weighting coefficients. The example method is shown in FIG. 5 as starting at step 502. The weighting coefficients for a road segment or for a plurality of road segments are determined at step 504. In an example implementation, the weighting coefficients may be previously calculated and stored in the map data, so that step 504 may include simply loading or extracting from the map data. When the reference time series are known, the approximated time series traffic data Yₐₚₚᵣₒₓ may be determined at step 506. This approximated traffic pattern may then be used in step 508 to determine the travel time for the different road segments. The determined travel time may be used to form the basis for the route destination in step 510 during calculation of the final route. The method is shown as ending at step 512.

It will be understood, and is appreciated by persons skilled in the art, that one or more processes, sub-processes, or process steps described in connection with FIGS. 1, 4 and 5 may be performed by a combination of hardware and software. The software may reside in software memory internal or external to the processing unit 126, FIG. 1, or other controller, in a suitable electronic processing component or system such as one or more of the functional components or modules depicted in FIG. 1. The software in memory may include an ordered listing of executable instructions for implementing logical functions (that is, “logic” that may be implemented either in digital form such as digital circuitry or source code or in analog form such as analog circuitry), and may selectively be embodied in any tangible computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store, communicate, propagate, or transport the program for use by or in connection with the instruction execution system, apparatus, or device. The computer readable medium may selectively be, for example, but is not limited to, an electronic, magnetic, optical, electromagnetic, infrared, or semiconductor system, apparatus, device, or medium. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic), and a portable compact disc read-only memory “CDROM” (optical) or similar discs (e.g., DVDs and Rewritable CDs). Note that the computer-readable medium may even be paper or another suitable medium upon which the program is printed, as the program can be electronically captured, via, for instance, optical scanning or reading of the paper or other medium, then compiled, interpreted or otherwise processed in a suitable manner if necessary, and then stored in the memory.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

What is claimed is:

1. A method for providing a traffic pattern for a road segment of navigation map data on the basis of time series traffic data Y(t), the method comprising:
determining reference time series ρ(t) for the road segment used to approximate the time series traffic data Y(t);
determining a weighted combination of the reference time series ρ(t) by determining weighted coefficients, α, that determine how much a predetermined reference time series contributes to the combination of the reference time series for approximating the time series traffic data Y(t);
approximating the time series traffic data Y(t) by the weighted combination of the reference time series ρ(t); and
linking the determined weighting coefficients α to the road segment of the navigation map data.

2. The method of claim 1 where the time series traffic data Y(t) and the reference time series ρ(t) contain time-dependent mean velocities of a road segment.

3. The method of claim 1 further comprising:
determining the number of weighting coefficients used for approximating the time series traffic data using the reference time series ρ(t).

4. The method of claim 1 where the step of determining reference time series ρ(t):
determining a limited number of representatives of the time series traffic data of the map data.

5. The method of claim 4 further comprising:
determining the representatives using a clustering method.

6. The method of claim 4 where the step of determining the weighting coefficients for the representatives comprises:
comparing the approximated time series traffic data for the road segment are compared to the time series traffic data of the road segment in a linear regression method.

7. The method of claim 1 further comprising:
determining the reference time series using standard basis functions, the time series traffic data being described on the basis of the standard basis functions; and
where the step of determining the weighting coefficients comprises at least carrying out a basis transformation in which the time series traffic data are described using the standard basis functions.

8. The method of claim 7 where the step of determining the weighting coefficients for the standard basis functions comprises using at least one of the following methods:
Discrete Fourier Transformation (DFT);
Fast Fourier Transformation (FFT);
Discrete Wavelet Transformation (DWT);
Discrete Cosine Transformation (DCT);
Single Value decomposition (SVD); and
Chebychev Polynomials; and
further comprising providing the standard basis functions when using one of the methods listed above.

9. The method of claim 7 where the step of determining the weighting coefficients α includes using at least one of the following methods:
Piecewise Aggregated Information (PAA); and
Adaptive Piecewise Constant Approximation (APCA).

10. The method of claim 1 further comprising determining the variance of the weighting coefficients α.

11. The method of claim 1 further comprising:
determining the number K of reference time series used to approximate the time series traffic data such that a difference between the time series traffic data and approximated traffic data using the weighted reference time series is smaller than a predetermined threshold.

12. The method of claim 1 where the navigation map data includes a plurality of road segments, the weighting coefficients α for each road segment being stored together with the road segment.

13. The method of claim 1 where the navigation map data includes a plurality of road segments, the weighting coefficients for each road segment being stored in a coefficient table together with a position information linking the weighting coefficients to one road segment.

14. The method of claim 1 where the time series traffic data for the road segment includes the time-dependent mean velocities for the road segment.

15. The method of claim 1 further comprising:
transmitting the weighting coefficients α and the reference time series ρ(t) for the road segment to a storage unit for storing the navigation map data;
storing the weighting coefficients together with the road segment; and
storing the reference time series ρ(t).

16. A method for determining a traffic pattern for a road segment of navigation map data, the method comprising:
providing time series traffic data Y(t) containing time-dependent mean velocities of the road segment;
determining weighting coefficients α for the road segment;
approximating the time series traffic data Y(t) of the road segment by a weighted combination of reference time series ρ(t) using the weighting coefficients α, where the reference time series are weighted using the weighting coefficients α determining how much a predetermined reference time series ρ(t) contributes to the combination of the reference time series for approximating the time series traffic data Y(t); and
approximating the traffic pattern using the determined weighting coefficients α.

17. The method of claim 16 further comprising:
calculating a fastest route to a predetermined destination by taking into account the approximated traffic pattern.

18. The method of claim 16 further comprising:
calculating a route having the lowest energy consumption on the basis of the approximated traffic pattern.

19. The method of claim 1 further comprising:
determining the variance, the skewness, or the kurtosis for the time series traffic data.

20. A system for providing a traffic pattern for a road segment on the basis of time series traffic data, the time series traffic data containing time-dependent mean velocities of the road segment, the system comprising:
a reference time series determining unit for determining reference time series for the road segment, the reference time series containing time-dependent mean velocities for the road segment;
a weighting coefficient determining unit for determining weighting coefficients for the road segment used for approximating the time series traffic data by a weighted combination of the reference time series ρ(t), where the reference time series are weighted using weighting coefficients α determining how much a predetermined reference time series ρ(t) contributes to the combination of the reference time series for approximating the time series traffic data Y(t); and
a storage unit for storing the determined weighting coefficients in connection with the road segment.

21. A computer storage medium comprising:
navigation map data having a plurality of road segments, each road segment being provided in connection with weighting coefficients α, the weighting coefficients α being used for approximating time series traffic data by a weighted combination of reference time series ρ(t), where the reference time series are weighted using the weighting coefficients α determining how much a predetermined reference time series ρ(t) contributes to the combination of the reference time series for approximating the time series traffic data Y(t).

22. A navigation system for determining a route to a predetermined destination comprising:
map data comprising a plurality of road segments, each road segment being provided in connection with weighting coefficients α(n), the weighting coefficients α(n) being used for approximating time series traffic data by a weighted combination of reference time series ρ(t), where the reference time series are weighted using the weighting coefficients α determining how much a predetermined reference time series ρ(t) contributes to the combination of the reference time series for approximating the time series traffic data Y(t);
traffic data approximation means for approximating the mean velocity for the road segments on the basis of the weighting coefficients; and
route determination means determining a route to a predetermined destination using the mean velocity calculated based on the weighting coefficients.
